(19) United States
(12) Patent Application Publication
(10) Pub. No.: US 2021/0091811 A1
(43) Pub. Date: Mar. 25, 2021

(54) RECEPTION DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Tatsuhisa FURUKAWA, Kawasaki (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 16/741,806

(22) Filed: Jan. 14, 2020

(30) Foreign Application Priority Data
Sep. 24, 2019 (JP) 2019-173474

(51) Int. Cl. H04B 1/10; H04B 1/713; G01S 3/10; G01S 3/04

(52) U.S. Cl. CPC H04B 1/1081; H04B 1/713; H04B 2201/71346; G01S 3/043; G01S 3/10

(57) ABSTRACT

A reception device according to an embodiment in a system that performs wireless communication while switching a frequency channel includes a channel selecting unit, a generation unit, and a determination unit. The channel selecting unit converts a received signal of the frequency channel into a channel signal of an intermediate frequency. The generation unit generates a received channel number in a predetermined scheme. The determination unit determines whether or not to save a signal used for azimuth estimation in a storage unit from the channel signal.

### CROSS-REFERENCE TO ULATED APPLICATION

This application is based upon and claims the benefit of priority from the prior Japanese Patent Application No. 2019-173474 filed on Sep. 24, 2019; the entire contents of which are incorporated herein by reference.

### FIELD

An embodiment described herein relates generally to a reception device.

### BACKGROUND

In recent years, an azimuth estimation function has been added to a next generation standard BLE5.1 (Bluetooth Low Energy 5.1) of Bluetooth (registered trademark) that is a wireless communication standard. This enables position tracking of objects and persons using radio waves of BLE. A reception device provided with such a BLE standard is required to have durability against a multipath environment in consideration of indoor use.

Although it is possible to alleviate degradation of signals due to influences of multiple paths by using a multipath canceller or the like as a countermeasure, there is a problem that the device becomes expensive. The capacity of a storage unit increases and the device becomes expensive as well, although it is possible to improve accuracy of azimuth estimation by increasing the number of packets used for azimuth estimation and performing weighted time multiplexing.

### BRIEF DESCRIPTION OF THE DRAWINGS

FIG. 1 is a block diagram illustrating an example of a configuration of a reception device according to an embodiment;

FIG. 2 is a diagram for explaining an example of channels used in an order of reception;

FIG. 3 is a diagram for explaining an example of channels used for saving control according to the embodiment;

FIG. 4 is a diagram for explaining a state when signals for azimuth estimation are saved in a storage unit in the order of reception; and

FIG. 5 is a diagram for explaining a state when the signals for azimuth estimation are saved in the storage unit through the saving control according to the embodiment.

### DETAILED DESCRIPTION

A reception device according to an embodiment in a system that performs wireless communication while switching a frequency channel includes a channel selecting unit, a generation unit, and a determination unit. The channel selecting unit converts a received signal of the frequency channel into a channel signal of an intermediate frequency. The generation unit generates a received channel number by a predetermined scheme. The determination unit determines whether or not to save a signal used for azimuth estimation in a storage unit from the channel signal based on the received channel number.

Hereinafter, the embodiment will be described in detail with reference to drawings.

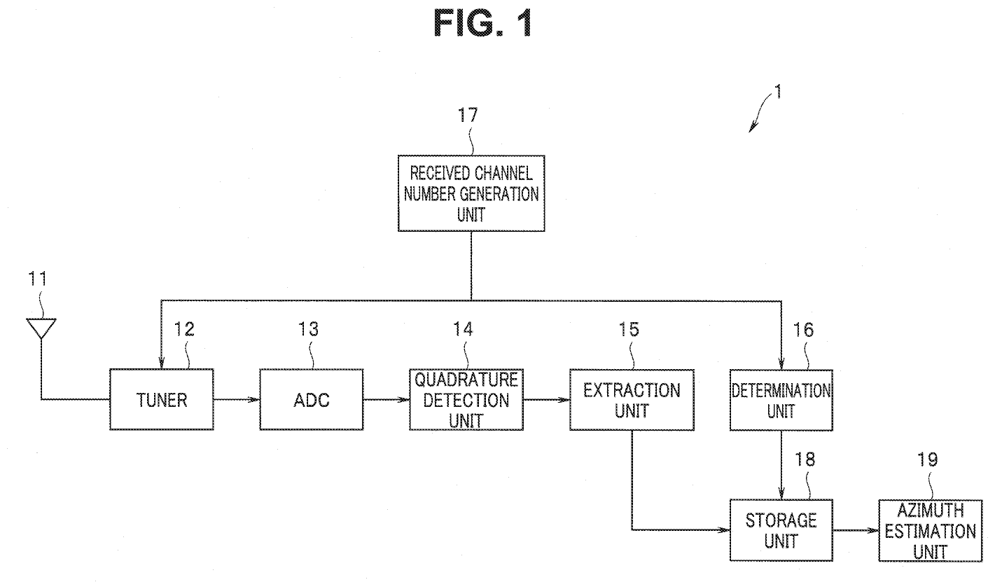

First, a configuration of a reception device according to an embodiment will be described based on FIG. 1. FIG. 1 is a block diagram illustrating an example of the configuration of the reception device according to the embodiment. A reception device 1 according to the embodiment is configured to include an antenna 11, a tuner 12, an analog/digital converter (hereinafter, referred to as an ADC) 13, a quadrature detection unit 14, an extraction unit 15, a determination unit 16, a received channel number generation unit 17, a storage unit 18, and an azimuth estimation unit 19.

The antenna 11 receives a signal in a wireless frequency band and outputs the signal to the tuner 12.

The tuner 12 that serves as the channel selecting unit selects a channel for the signal received by the antenna 11 in accordance with a received channel number from the received channel number generation unit 17, converts the signal into a signal of an intermediate frequency, and outputs the signal to the ADC 13. Note that the tuner 12 may convert the signal received by the antenna 11 into a signal of an intermediate frequency regardless of the received channel number.

The ADC 13 performs analog-to-digital conversion on the signal of the intermediate frequency and outputs the signal to the quadrature detection unit 14.

The quadrature detection unit 14 converts the digital signal of the intermediate frequency into a baseband signal and outputs the signal to the extraction unit 15.

The extraction unit 15 extracts a signal (field) used for azimuth estimation from the baseband signal and outputs the signal to the storage unit 18. Although the signal for azimuth estimation is a constant tone extension (CTE), the signal is not limited to a CTE but may be another signal.

In a case in which the received channel number from the received channel number generation unit 17 and a received channel number, which is received in the past, a signal for azimuth estimation of which is saved in the storage 18, are compared, if the result shows that, the received channel numbers are separated from each other by N channels or more, the determination unit 16 outputs to the storage unit 18 a command for saving the signal for azimuth estimation. Note that N is a predetermined number that can arbitrarily be set. The received channel number, which is received in the past, a signal for azimuth estimation of which is saved in the storage unit 18, may be a received channel number received in the past.

The received channel number generation unit 17 outputs the received channel number generated in a predetermined scheme to the tuner 12 and the determination unit 16. The received channel number is a signal indicating a channel number of a channel as a target of reception performed by the reception device 1. The received channel number can be replaced with an arbitrary signal that can uniquely specify the channel as a target of reception performed by the reception device 1 and the channel number of the channel. According to the BLE standard, a channel switching sequence is defined in advance by a communication protocol. Therefore, the received channel number generation unit 17 generates the received channel number in accordance with the channel switching sequence.

The reception device 1 according to the embodiment has thirty eight channels. Channel numbers CH0, CH1, . . . , CH37 that are continuous in an order from a low frequency band to a high frequency band are applied to the respective channels. In this specification, a channel of a channel number Chin (n is 0 to 37) will be referred to as a channel Chin. Note that the channel numbers in the embodiment indicate height relationships of frequency bands of the respective channels. Therefore, it is not necessary for the respective channels to be managed with numbers, and it is possible to manage the respective channels in an arbitrary scheme in which the channel numbers can be specified in the reception device 1.

The received channel number generation unit 17 generates received channel numbers in an order of the channel CH8, the channel CH1, the channel CH7, the channel CH20, the channel CH15, . . . in the embodiment.

The storage unit 18 saves the signal for azimuth estimation in accordance with the command from the determination unit 16. The storage unit 18 does not save the signal for azimuth estimation in a case in which no command is provided from the determination unit 16.

The azimuth estimation unit 19 performs azimuth estimation processing based on a plurality of signals for azimuth estimation saved in the storage unit 18. In the embodiment, the azimuth estimation unit 19 performs the azimuth estimation processing based on four signals, for example. If the azimuth estimation unit 19 executes the azimuth estimation processing, then the plurality of signals for azimuth estimation saved in the storage unit 18 are deleted.

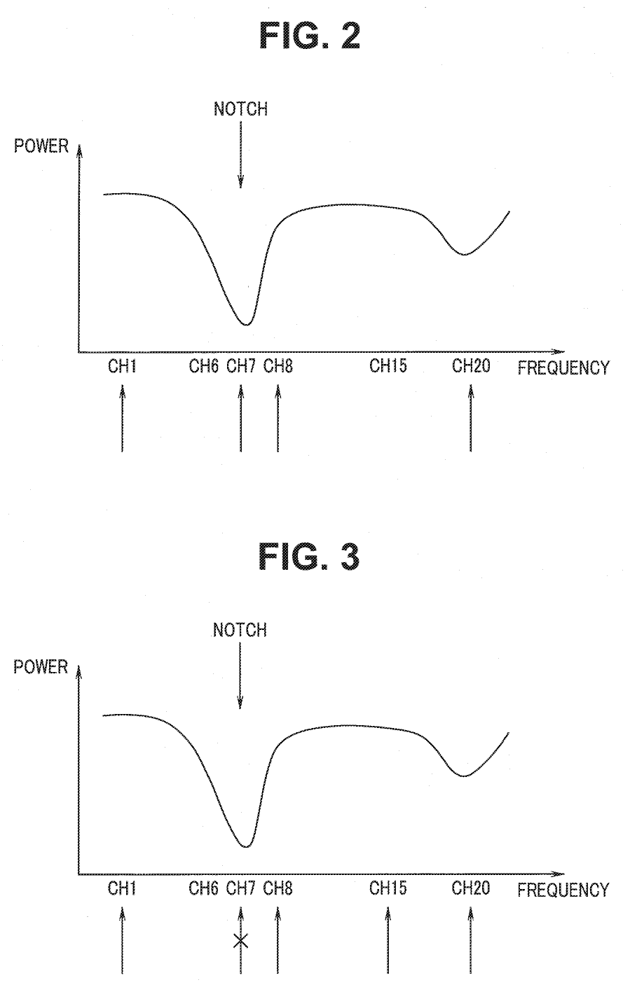

Next, operations of the reception device 1 configured as described above will be described using FIGS. 2 to 5. Description will be given on the assumption that reception is performed in the order of the channels CH8, CH1, CH7, CH20, CH15, . . . in FIGS. 2 to 5. It is also assumed that a notch is included in the frequency of the channel CH7 and quality of the received signal is degraded. Note that quality of the received signal will be referred to as reception quality in the following description. Some channels are chosen and illustrated as representatives in FIGS. 2 and 3 for simplification. In FIGS. 2 and 3, the vertical axis represents power of the received signal while the horizontal axis represents a frequency of the received signal.

In a case in which the reception device 1 is used indoors, for example, inclusion of a notch in a frequency due to influences of multiple paths is conceivable. In a case in which a notch is included in the frequency of the channel CH7, for example, there is a high probability that reception quality of the channels CH6 and CH8 before and after CH7 is also degraded.

FIG. 2 is a diagram for explaining an example of channels used in an order of reception. In the case of FIG. 2, signals of the channels CH8, CH1, CH7, and CH20 are used for azimuth estimation since the signals are saved in the storage unit 18 in the order of reception. In FIG. 2, the arrows applied to the channels CH8, CH1, CH7, CH20, and CH15 represent that received signals of the channels are targets of saving in the storage unit 18. If the signals are simply saved in the storage unit 18 and are used for azimuth estimation in the order of reception in this manner, there is a probability that a plurality of signals with degraded reception quality are used, and there is a probability that accuracy of azimuth estimation is degraded. The signals with degraded reception quality are, for example, signals from received signals with low SN ratios or signals from received signals with low power.

According to the embodiment, azimuth estimation is thus performed using channels in a plurality of frequency bands. FIG. 3 is a diagram for explaining an example of channels used for saving control according to the embodiment. In a case in which a received channel number from the received channel number generation unit 17 is separated from a received channel number received in the past by five channels or more, for example, the determination unit 16 outputs, to the storage unit 18, a command for saving a signal for azimuth estimation output from the extraction unit 15.

The channel CH7 is not separated from the channel CH8 received in the past by five channels or more, the signal of the channel CH7 is neither saved nor used for azimuth estimation. In this manner, the reception device 1 does not perform azimuth estimation using a plurality of signals with degraded reception quality, and accuracy of the azimuth estimation is thus improved.

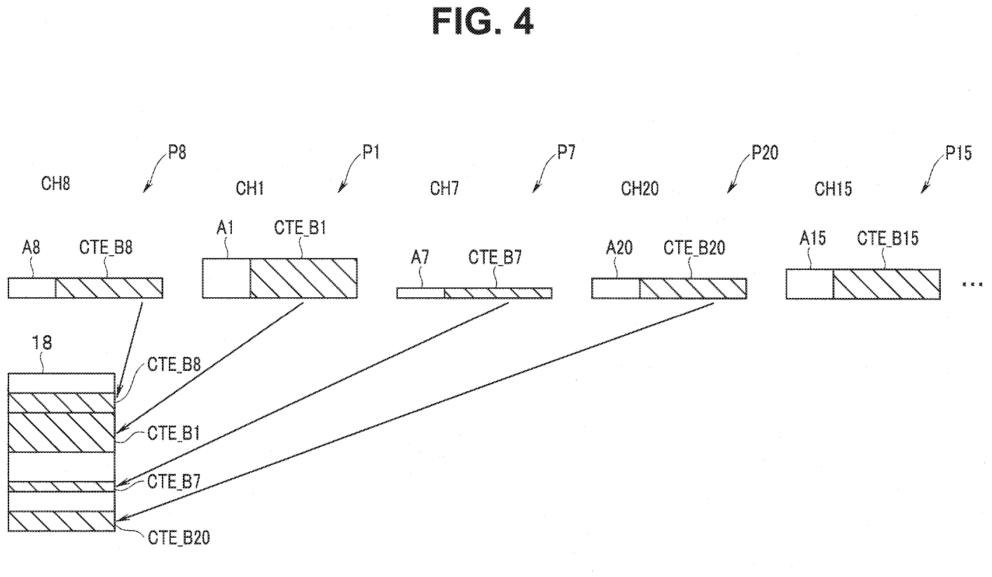

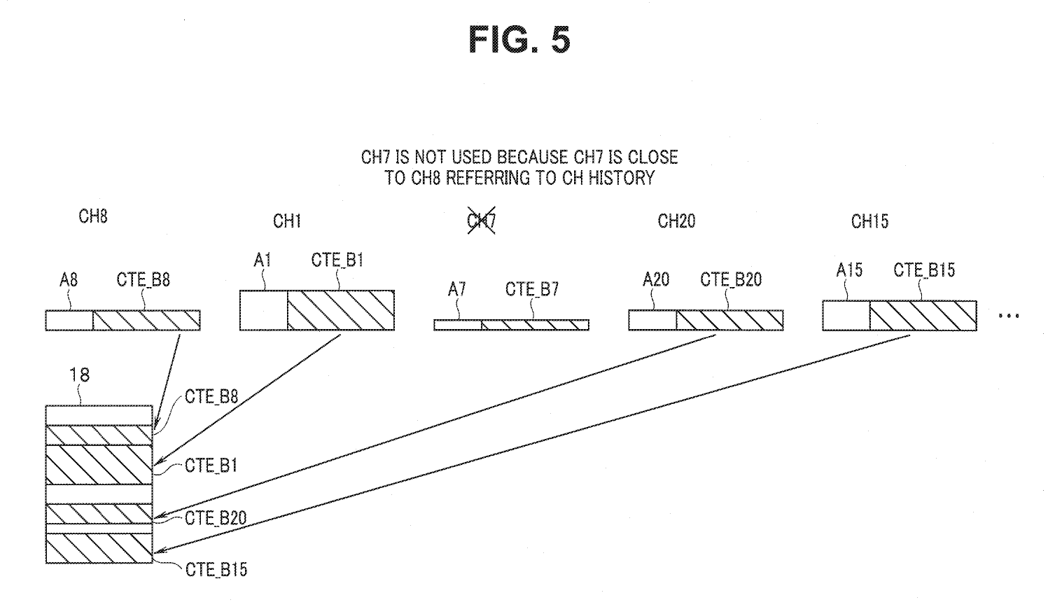

FIG. 4 is a diagram for explaining a state when signals for azimuth estimation are saved in the storage unit in an order of reception, and FIG. 5 is a diagram for explaining a state when signals for azimuth estimation are saved in the storage unit through saving control according to the embodiment. In FIGS. 4 and 5, packets for azimuth estimation of the respective channels CH8, CH1, CH7, CH20, and CH15 are defined as P8, P1, P7, P20, and P15, respectively.

In FIGS. 4 and 5, the thicknesses of the packets P8, P1, P7, P20, and P15 represent how high the reception quality of the respective packets P8, P1, P7, P20, and P15 is. Specifically, a thick packet indicates satisfactory reception quality, and a thin packet represents degraded reception quality. In other words, the packet P1 has large thickness that represents satisfactory reception quality in the embodiment. On the other hand, the packet P7 has small thickness that represents degraded reception quality.

The packet P8 has a field A8 configured of a preamble access address protocol data unit (PDU) and a CRC. A signal used for azimuth estimation is applied to the field A8. In the following description, the signal for azimuth estimation will be referred to as a constant tone extension (CTE), and the signal for azimuth estimation of the packet P8 will be described as CTE_B8.

The other packets P1, P7, P20, and P15 also have configurations that are similar to the configuration of the packet P8. The packet P1 has a field A1 and CTE_B1, the packet P7 has a field A7 and CTE_B7, the packet P20 has a field A20 and CTE_B20, and the packet P15 has a field A15 and CTE_B15.

In the case of FIG. 4 in which CTEs are saved in the order of reception, the storage unit 18 saves CTE_B8, CTE_B1, CTE_B7, and CTE_B20. If a notch is included in the frequency of the channel CH7 due to influences of multiple paths, there is a probability that CTE_B8 and CTE_B7 with reception quality degraded due to closeness to the channel are used for azimuth estimation, and there is a concern that accuracy of the azimuth estimation is degraded.

On the other hand, according to the embodiment, CTEs of channels that are close to a channel received in the past are not saved in the storage unit 18 with reference to a channel history as illustrated in FIG. 5.

First, a received channel number of the channel CH8 is input from the received channel number generation unit 17 to the determination unit 16. The determination unit 16 compares the input received channel number (channel CH8) with a past received channel number, and no past received channel number is found. The determination unit 16 provides a command for saving CTE_B8 to the storage unit 18. In this manner, CTE_B8 is saved in the storage unit 18.

Next, a received channel number of the channel CH1 is input from the received channel number generation unit 17 to the determination unit 16. The determination unit 16 compares the input received channel number (channel CH1) with the past received channel number (channel CH8). Since the channel CH1 is separated from the channel CH8 by five channels or more, the determination unit 16 provides a command for saving CTE_B1 to the storage unit 18. In this manner, CTE_B1 is saved in the storage unit 18.

Next, a received channel number of the channel CH7 is input from the received channel number generation unit 17 to the determination unit 16. The determination unit 16 compares the input received channel number (channel CH7) with the past received channel numbers (the channel CH8 and the channel CH1). Although the channel CH7 is separated from the channel CH1 by five channels or more, the channel CH7 is not separated from the channel CH8 by five channels or more. Therefore, the determination unit 16 provides a command for not saving CTE_B7 to the storage unit 18. In this manner, CTE_B7 is not saved in the storage unit 18. Similarly, the determination unit 16 compares the received channels CH20 and CH15 with the past received channel numbers and provides commands for saving or not saving CTEs to the storage unit 18. In this manner, CTE_B8, CTE_B1, CTE_B20, and CTE_B15 are saved in the storage unit 18. The azimuth estimation unit 19 performs azimuth estimation using the four saved CTEs, namely CTE_B8, CTE_B1, CTE_B20, and CTE_B15.

As described above, the reception device 1 saves in the storage unit 18 CTEs of channels that are separated from past received channel numbers by N channels or more and performs azimuth estimation. In other words, the received channel numbers of the channels that are close to the channels received in the past are neither saved in the storage unit 18 nor used for azimuth estimation. As a result, the reception device 1 does not perform azimuth estimation using a plurality of signals with reception quality degraded by inclusion of a notch in a frequency due to influences of multiple paths. Therefore, it is possible to improve accuracy of azimuth estimation without significantly increasing the capacity of the storage unit even in a multipath environment according to the reception device in the embodiment.

Note that the determination unit 16 compares the received channel number from the received channel number generation unit 17 with the received channel numbers received in the past and determines whether or not to save the CTE in the storage unit 18 in the embodiment, but the embodiment is not limited thereto.

For example, the determination unit 16 may sequentially save CTEs of received channels in the storage unit 18, and in a case in which a channel with higher reception quality than reception quality of CTEs saved in the storage unit 18 is received, the determination unit 16 may replace the CTE of a channel with degraded reception quality with a CTE of a channel with higher reception quality. Alternatively, the determination unit 16 may save CTEs of channels from received signals with power that is higher than a predetermined threshold value in the storage unit 18. At this time, the determination unit 16 receives a signal selected by the tuner 12 and measures reception quality and power of the received signal.

Alternatively, the determination unit 16 may save a history, specifically, channels, the saving of which in the storage unit 18 is ordered through commands in the past and may save CTEs of the saved channels in the storage unit 18. Alternatively, the determination unit 16 may save an experimental rule in the past, specifically, channels with high accuracy in azimuth estimation performed in the past and may save CTEs of the saved channels in the storage unit 18. At this time, the determination unit 16 receives a result of azimuth estimation processing from the azimuth estimation unit 19 and measures accuracy of the azimuth estimation.

The determination unit 16 may select CTEs of channels to be saved in the storage unit 18 from a wide range. In a case in which there are thirty eight channels from the channel CH0 to the channel CH37, for example, the determination unit 16 may always save in the storage unit 18 a CTE of the channel CH0 and a CTE of the channel CH37, which are the outermost channels. In a case in which there are a plurality of channels the channel numbers are typically applied to the channels from a lower frequency band in an order of channels CH0, CH1, . . . , CH37. Therefore, the determination unit 16 always saves, in the storage unit 18, the CTE of the channel in the lowest frequency band and the CTE of the channel in the highest frequency band as the outermost channels.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reception device in a system that performs wireless communication while switching a plurality of frequency channels, the reception device comprising:
a channel selecting unit configured to convert at least one received signal of the frequency channels into a channel signal of an intermediate frequency;
a generation unit configured to generate at least one received channel number in a predetermined scheme; and
a determination unit configured to determine whether or not to save a signal used for azimuth estimation in a storage unit from the channel signal based on the received channel number.

2. The reception device according to claim 1, wherein the channel selecting unit converts a received signal selected in accordance with the received channel number from the generation unit into the channel signal.

3. The reception device according to claim 2, wherein the determination unit outputs a command for saving the signal used for azimuth estimation in the storage unit in a case in which the received channel number of the channel signal is separated from a received channel number of a received signal received in the past by a predetermined number.

4. The reception device according to claim 1, comprising:
an extraction unit configured to extract the signal used for azimuth estimation from the channel signal.

5. The reception device according to claim 1, comprising:
an azimuth estimation unit configured to perform azimuth estimation processing based on a plurality of signals saved in the storage unit.

6. The reception device according to claim 1, wherein in a case in which a second received signal with higher quality than quality of a first received signal received in the past is received. the determination unit provides, to the storage unit, a command for replacing a signal'used for azimuth estimation obtained from the first received signal with a signal used for azimuth estimation obtained from the second received signal and saving the signal used for azimuth estimation obtained from the second received signal.

7. The reception device according to claim 1, wherein in a case in which power of the channel signal is greater than a predetermined threshold value, the determination unit provides, to the storage unit, a command for saving the signal used for azimuth estimation in the storage unit.

8. The reception device according to claim 1, wherein when a received channel number is smallest or largest among the received channel numbers generated by the generation unit, the determination unit provides a command for saving the signal used for azimuth estimation in the storage unit,

9. The reception device according to claim 2, wherein in a case in which the received channel number of the channel signal is separated from a received channel number of a received signal, from which a signal used for azimuth estimation is saved in the storage unit, by a predetermined number., the determination unit outputs a command for saving the signal used for azimuth estimation in the storage unit.

10. The reception device according to claim 3, wherein the predetermined number is a number that is equal to or greater than two.

11. A reception device in a system that performs wireless communication while switching a plurality of frequency channels, the reception device comprising: a channel selecting unit configured to convert at least one received signal of the frequency channels into a first signal of an intermediate frequency;
a generation unit configured to generate a second signal indicating the frequency channel as a target of reception in a predetermined scheme; and
a determination unit configured to determine whether or not to save a third signal used for azimuth estimation in a storage unit from the first signal based on the second signal.

12. The reception device according to claim 11., wherein the channel selecting unit converts a received signal selected in accordance with the second signal from the generation unit into the first signal,

13. The reception device according to claim 12, wherein the frequency channel includes a channel number, which is one of channel numbers successively applied to a plurality of frequency channels that the reception device includes, in an ascending or a. descending order of a frequency band, and in a case in which the channel number of the frequency channel indicated by the second signal is separated from a channel number of a frequency channel received in the past by a predetermined number, the determination unit outputs a command for saving the third signal in the storage unit.

14. The reception device according to claim 13, wherein the predetermined number is a number that is equal to or greater than two.

15. The reception device according to claim 12,
wherein the frequency channel includes a channel number, which is one of channel numbers successively applied to a plurality of frequency channels that the reception device includes in an ascending or a descending order of a frequency band, and
in a case in which the channel number of the frequency channel indicated by the second signal is separated from a channel number of a frequency channel, in which a third signal received in the past is saved in the storage unit, by a predetermined number, the determination unit outputs a command for saving the third signal in the storage unit.
